(19) United States
(12) Patent Application Publication
(10) Pub. No.: US 2007/0075285 A1
(43) Pub. Date: Apr. 5, 2007

(54) Linear electrical drive actuator apparatus with tandem fail safe hydraulic override for steam turbine valve position control

(76) Inventor: Kim Alan Lovejoy, Waukesha, WI (US)

Correspondence Address: Kim A. Lovejoy;Lovejoy Controls Corporation, 1301 Sentry Drive, 53186, PO Box 702, Waukesha, WI, 53187, US

(21) Appl. No.: 11/243,793

(22) Filed: Oct. 5, 2005

(51) Int. Cl. F16K 31/02

(52) U.S. Cl. 251/129.03

(57) ABSTRACT

The invention consists of turbine steam valve actuation apparatus providing both precise modulation of valve position control and independent fail-safe emergency valve closure regardless of modulated position. The invention consists of a tandem arrangement of an electric valve actuator (utilizing a roller or ball screw drive mechanism) operated by a conventional servo position controller under resolver feedback with a hydraulic cylinder of equal or greater stroke supplied by a conventional synthetic fluid delivery system. The electric actuator and the hydraulic cylinder are reversible in installed positions and applicable to both direct steam valve stem coupling and operation of fulcrumed lever valve racks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

It is widely known in the practice of valve control that direct-drive actuation of modulating valves improves finite position control of a steam turbine control valve by providing more predictable response. The action of a motor rotation to valve stem coupling through a roller screw or ball screw mechanism of an electric actuator results in final valve motion control with less deadband and more precision. The electric actuator can be controlled to provide more accurate response characteristics of velocity and resolution through its motor shaft encoder/resolver than its hydraulic cylinder counterpart can using linear position feedback of the piston. In hydraulic cylinder positioning systems feed forward control techniques, or predictably and accurately applying position corrections without immediate feedback, are not successful due to insufficient knowledge of the position loop deadband attitude. The deadband attitude is defined as the immediate output position within the hysterisis of the position control loop. For example, if the hydraulic cylinder position control loop resides with a deadband attitude at the full extent of the hysterisis in the valve closure direction, further closure position demand results in immediate and further valve closure motion. Contrarily, if the same hydraulic cylinder positioning system is demanded to reverse direction for valve opening the entire deadband must be traversed followed by valve motion inducing feedback and resulting in one or more moderation corrections. The electric actuator having the direct roller screw or ball screw drive has a much smaller hysterisis than the hydraulic cylinder positioning system and the deadband attitude at any time is well defined based upon the immediate motor drive polarity and magnitude.

This improvement in control capability is a needed advancement in steam turbine control to improve response in grid upset scenarios which can lead to regional blackouts. Turbine governors or speed controllers comprise the first corrective action upon upsets of the power generation grid frequency. Rapid, accurate response of turbine governors through turbine steam valve actuator apparatus is necessary for stable grid frequency control. Improvements in turbine steam valve control precision and accuracy such are available from this invention will directly improve power grid stability.

This improvement in control capability is also a needed advancement in reducing turbine blade stress by providing feed forward response of sufficient speed and accuracy to dampen turbine rotor torsional vibration. Torsional vibration is the electrical load oscillation of generator torque at twice grid frequency which has been shown to resonate and fail turbine blade components.

The electric actuator's stand alone application in prior art, however, suffers a significant drawback in application to steam turbine valve control in that if drive power to the motor is interrupted the actuator retains a large opposing torque which resists rapid motion and prevents a subsequent fail safe closure in sufficient time to meet criteria to protect the turbine elements in turbine over speed incidents. Turbine over speed incidents are most critically suffered when the turbine load is suddenly removed under a condition of loss of the valve modulation system due to failure. This lacking feature of electric actuators is known in the trade as “Fail-Safe Closure” or “Emergency Trip”.

The hydraulic cylinder's stand alone application in prior art requires the burden of much higher flow synthetic oil fluid delivery systems than the invention apparatus to provide sufficient performance to move steam turbine control valves at typical positioning velocities of five (5) inches per second. The hydraulic cylinder's stand alone application in prior art also must have synthetic oil fluid delivery systems which have continuously operated motor driven pumps representing a higher net parasitic electrical load than the standby operated pumps of the working-hold delivery system for the invention apparatus which in which the high pressure, typically 2000 pounds per square inch fluid supply is consumed only in initial steam valve opening and can thenceforth be satisfied by comparatively small capacity pumps and accumulators.

### BRIEF SUMMARY OF THE INVENTION

A steam turbine valve positioning actuator apparatus consisting of the tandem coupling of an electric roller-screw or ball-screw actuator with a hydraulic cylinder and accessory components is disclosed. The apparatus is useful in providing the combination of precise direct-drive modulated low hysterisis control and fail-safe emergency valve closure in both in-line valve stem coupled and fulcrumed lever operated valves for steam turbine control. The apparatus exploits the superior modulation control of the electric actuator having external servo drive positioning with superior fail safe closure action of the hydraulic cylinder having external pressure control.

### BRIEF DESCRIPTION OF SEVERAL VIEWS OF THE DRAWING

Functional diagram FIG. 1a identifies the interconnections and the component operating positions of the invention in the normal operating mode with the hydraulic cylinder reset.

Functional diagram FIG. 1b identifies the interconnections and the component operating positions of the invention in the fail safe closed operating mode with the hydraulic cylinder tripped.

Functional diagram FIG. 1c identifies the interconnections and the component operating positions of the invention in the reset process of electric actuator extension with the hydraulic cylinder tripped.

Functional diagram FIG. 1d identifies the additional components to the apparatus comprising the valve test function.

FIG. 2 depicts a cut-away assembly view of the invention in direct valve stem positioning applications.

FIG. 3a depicts a front elevation of the invention in fulcrum lever operated application.

FIG. 3b depicts a side elevation of the invention in fulcrum lever operated application.

FIG. 4 depicts an orthographic projection of the fulcrum lever operated application with revealed internal components.

### DETAILED DESCRIPTION OF THE INVENTION

In the first application the apparatus is fitted by coupling to a valve stem. The tandem coupling of the electric actuator 1 case and the hydraulic cylinder piston 3 respectively provides both precise modulation and fail-safe trip closure capabilities. The hydraulic cylinder 2 body is fixed to the spool piece 8 which bolts to the valve flange 13 at its opposite end.

With the trip line A pressurized to reset status (FIG. 1a) by a conventional synthetic fluid delivery system the hydraulic solenoid 1 8 ports the working delivery pressure B to the hydraulic cylinder 2 upper chamber through a flow-limiting orifice and ports the hydraulic cylinder 2 lower chamber directly to a low positive pressure drain which results in a controlled, relatively slow (1.0 inch/second typical) hydraulic piston retraction stroke to the lowest (reset) position. This enables the retraction stroke range of the electric actuator 1 to be used to fully open, close, or modulate the steam admission valve opposing the valve closure spring 9 force. In this manner the hydraulic cylinder piston 3 serves as an enabling operating position reference for the electric actuator 1.

If the trip line A is de-pressurized (FIG. 1b) by conventional external means such as a redundant trip solenoid valve dumping trip line A to drain, the hydraulic solenoid 1 8 drains the upper cylinder chamber through a control orifice chosen for optimized closure speed (typically 5.0 inches/second) to drain line C, thus the valve closure spring 9 is no longer opposed by the cylinder differential pressure working upon the piston 3 causing the turbine steam valve to close. As the closing valve 6 approaches the seat 7 the shock damping diaphragm spring pad 10 begins compression to reduce end stop impact forces.

From the condition illustrated in FIG. 1b the apparatus is reset by an external controller for further operation by first fully extending he electric actuator operating rod 4 as shown in FIG. 1c. Once this is confirmed by linear feedback device 1 5 signal E, the trip line A pressure may be re-applied again permitting the retraction stroke range of the electric actuator 1 to be used to fully open, close, or modulate the steam admission valve opposing the valve closure spring 9 force.

Certain steam turbine valves will possess equivalent closure spring 9 and shock absorbing spring 10 in various positions with respect to bushing 19 and leak off line 14. In such valves the mounting of the closure spring 9 and the impact spring 10 are omitted from the apparatus spool piece 8.

FIG. 1d adds a valve test capability required of main steam stop valve applications to the apparatus in the form of an electric solenoid operated valve 20 which may selectively open an orificed line 21 connecting the hydraulic cylinder upper chamber and the drain line C. Upon energization of the normally closed electric solenoid operated valve 20, a metered flow of hydraulic cylinder 2 upper cylinder oil is bled to drain line C causing a gradual closing of the valve as detected by linear transducer 15. At a pre-determined closure percentage the electric solenoid operated valve 20 is de-energized, returning the valve to the previous operating position. This process functionally tests the active motion of the hydraulic cylinder without fully closing the steam valve.

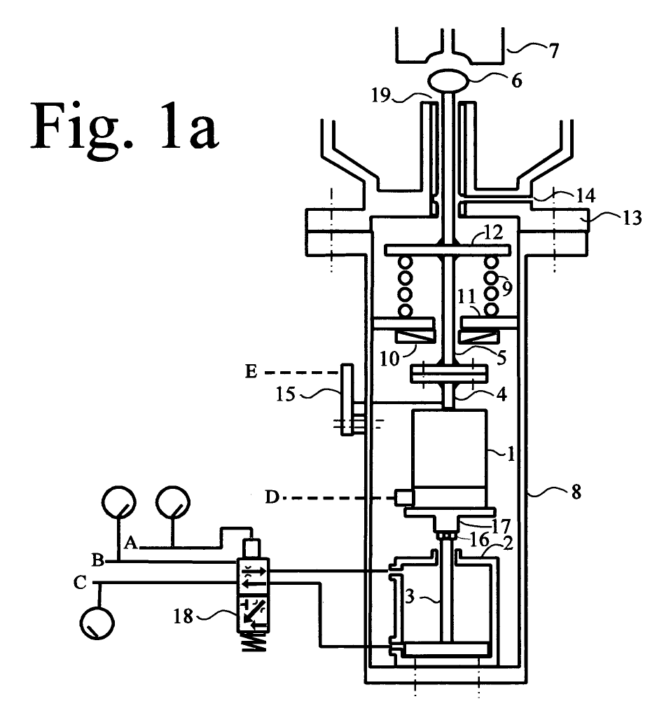

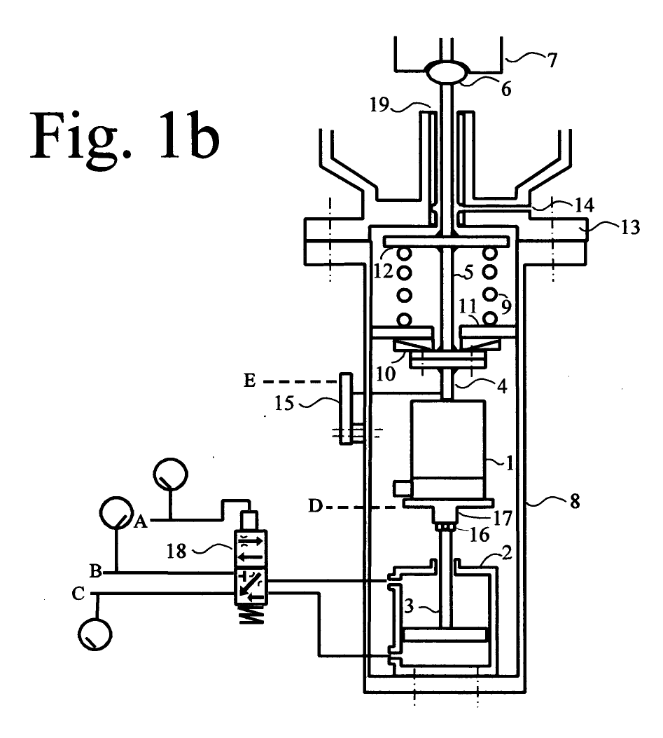

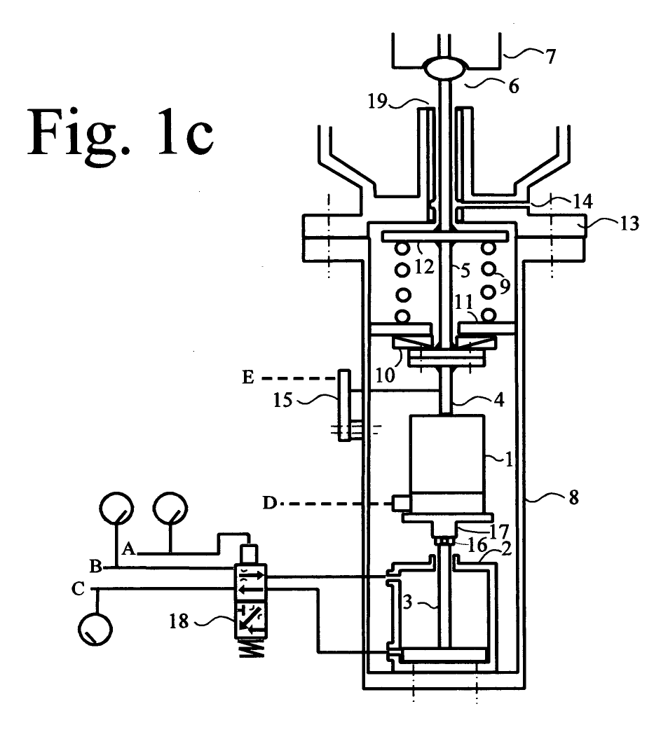

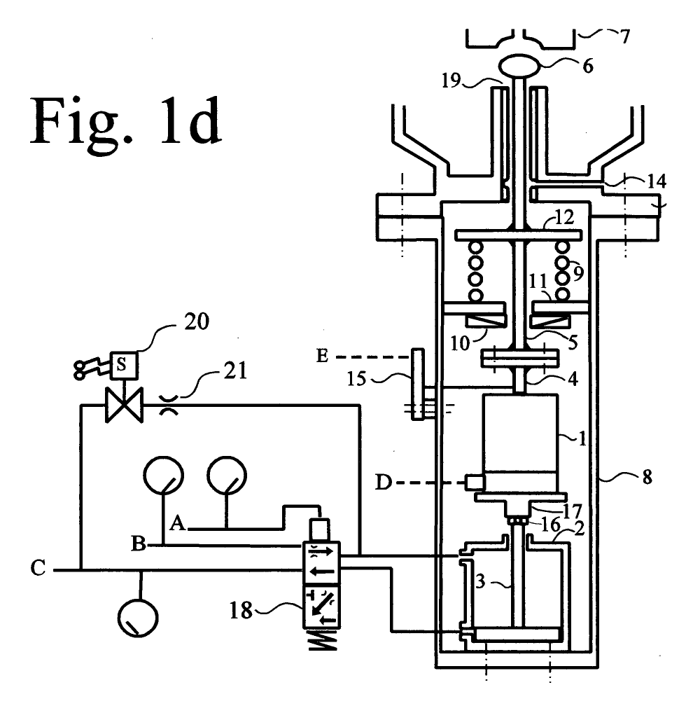

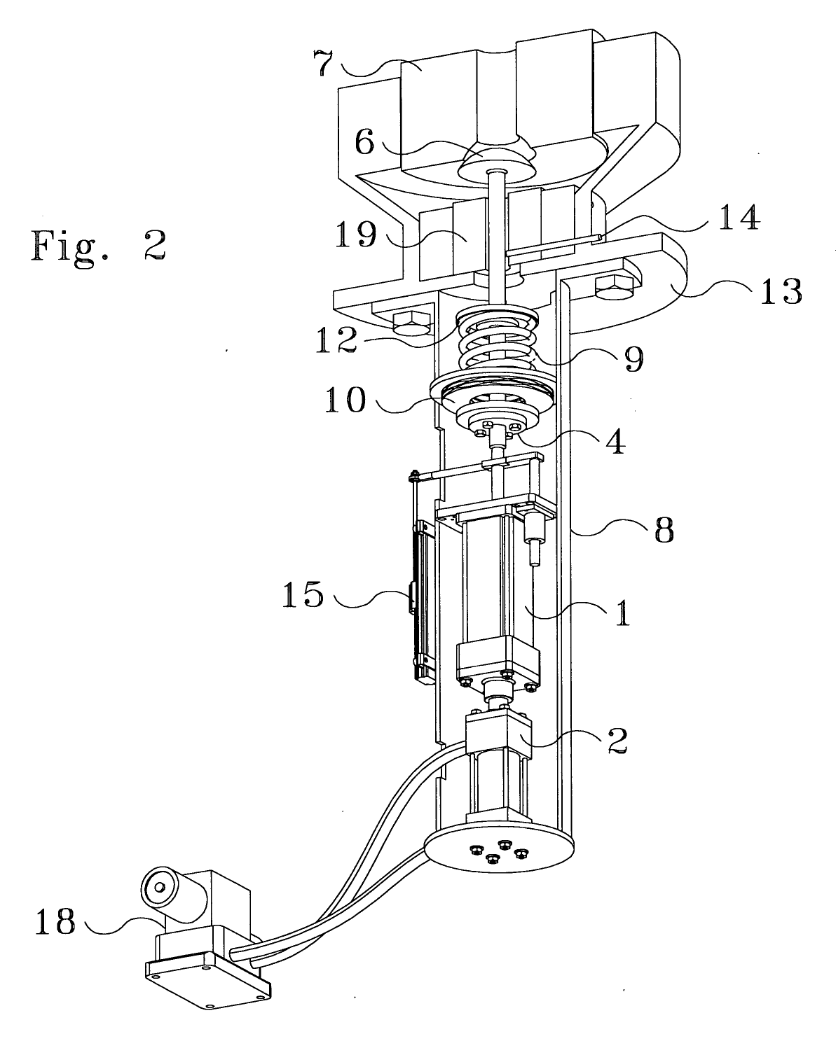

The apparatus is further illustrated in FIG. 2, providing a cut-away orthographic view. The hydraulic solenoid (18) may be mounted to the spool piece (8) or mounted to a rigid nearby support as shown.

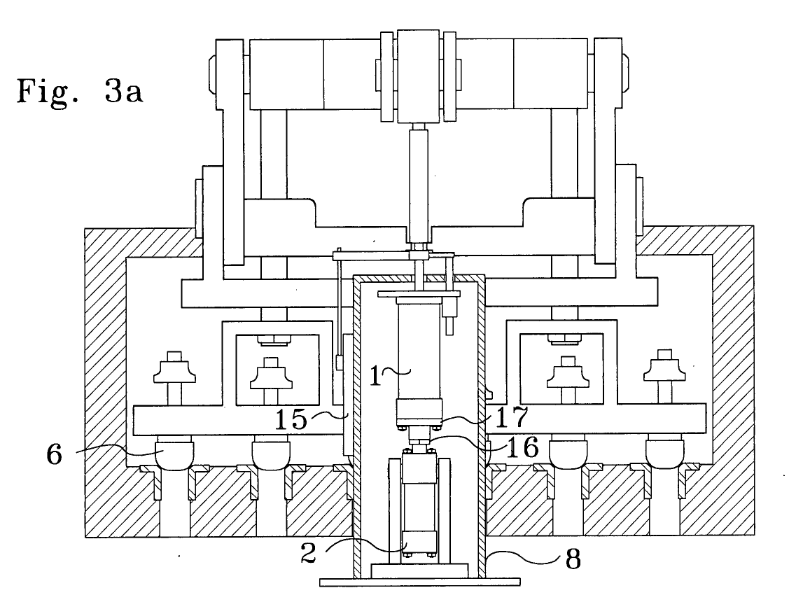

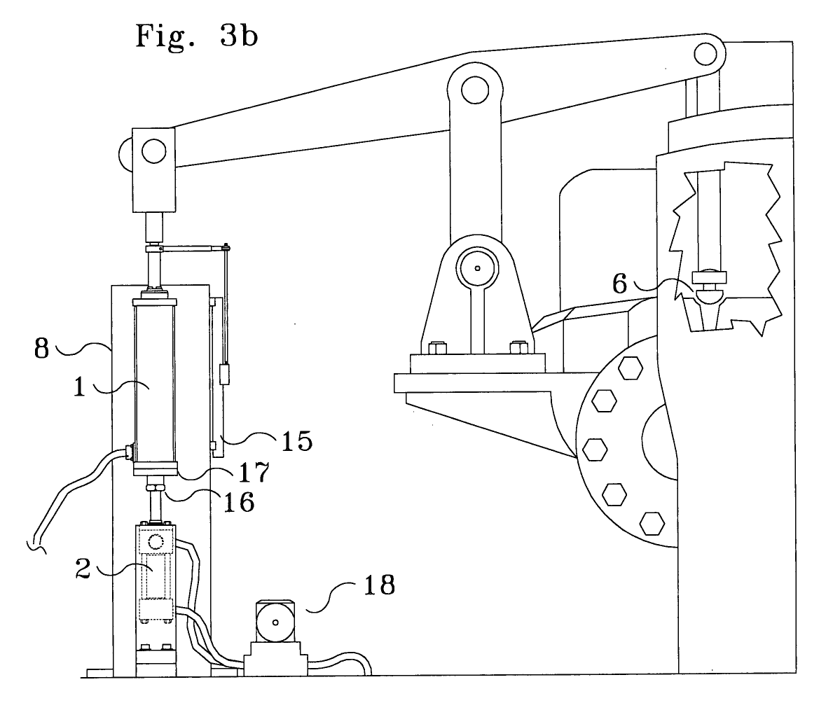

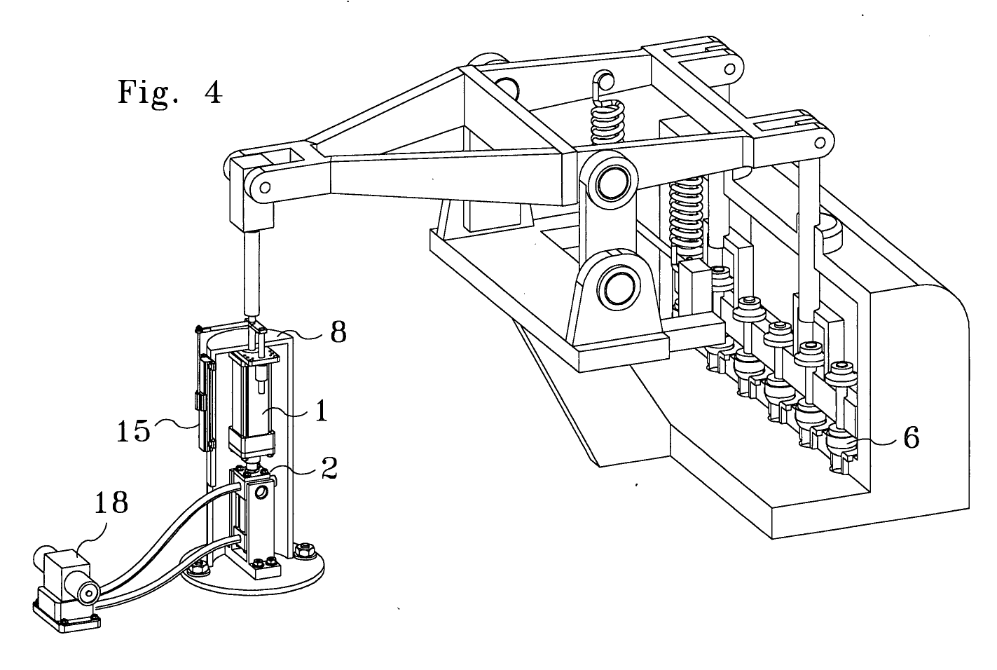

On steam turbines having fulcrumed lift bar steam valve linkages the second embodiment of the invention is applied as illustrated in FIG. 3a, Front Elevation, and FIG. 3b, Side Elevation. In operating fulcrumed lift bar steam valve linkages the spool piece is omitted and either the electric actuator 1 or the hydraulic cylinder 2 is fitted with a trunion mount 19 which is supported to a turbine pedestal mounting plate with a trunion yoke 22. Other than the trunion mount replacing the spool piece, all other operation is the same as in the first application. FIG. 4 provides a orthographic view of a typical second embodiment of the invention illustrating internal components in typical operating position.

What I claim as my invention is:

1. A linear actuator apparatus for steam turbine steam control valve positioning comprising:
an electric actuator controlled by an external servo drive position controller utilizing motor with resolver feedback, driving a ball or roller screw for linear motion, mechanically coupled by its case to a hydraulic cylinder piston. The stroke capability of the electric actuator shall be equivalent to the steam control valve modulation range. The stroke capability of the hydraulic cylinder shall be greater than the stroke capability of the electric actuator but not so great as to provide contact between the steam valve and valve case or attached components upon full retraction of both the electric actuator and hydraulic actuator.
an attachment of the hydraulic cylinder operating rod to the case of the electric actuator with a suitable adaptive piece matching each component end.

2. An apparatus as recited in claim 1,
wherein a mounting spool piece providing a center bore containing a rigid mounting of the hydraulic cylinder frame using enlarged mounting holes and dowel pins for precision position of attachment and a flange mount matching multiple studs of the steam control valve flange likewise with enlarged mounting holes and dowel pins for precision position of attachment.

3. An apparatus as recited in claim 2,
wherein a coupling of the electric actuator operating rod to the steam control valve stem with a rigid coupling of minimum diameter of two-inches to permit alignment gap measurements between separated coupling halves determining final dowel installation for initial fits.
a closure spring fit between a fixed collar of the valve stem and an internal disk of the mounting spool piece arranged to provide an opposition force to the opening of the steam control valve, provided such a closure spring is not already provided in the steam control valve design.
an impact absorbing diaphragm spring pack fixed to the spool piece disk which contacts the steam valve stem coupling prior to the steam valve contacting its seat.
a feedback instrument for absolute linear reference upon power restart consisting of a linear transducer of the linear potentiometer, linear variable differential transformer, or other linear signal transmitting device and to serve as an anti-rotation device necessary for the electric actuator extension and retraction.

4. An apparatus as recited in claim 1,
wherein the electric actuator case or the hydraulic cylinder case is fitted with a trunion mount fitted to a trunion yoke mounted to a steam turbine pedestal.
wherein the electric actuator operating shaft is attached to a pivot linkage which operates the opening and closing of one or more steam turbine governor valves.

5. An apparatus as recited in claim 1,
wherein the hydraulic cylinder is single-acting and having a vent port in place of the dual port double-acting hydraulic cylinder illustrated in the figures.

6. An apparatus as recited in claim 6,
wherein the hydraulic cylinder is single-acting and having a vent port in place of the dual port double-acting hydraulic cylinder illustrated in the figures.
